(19) United States
(12) Patent Application Publication
(10) Pub. No.: US 2021/0329855 A1
(43) Pub. Date: Oct. 28, 2021

(54) Apparatus for the Automated Repair of Pitch Marks

(71) Applicant: Richard Charles Kalil, JR., Clearwater, FL (US)

(72) Inventor: Richard Charles Kalil, JR., Clearwater, FL (US)

(21) Appl. No.: 17/232,957

(22) Filed: Apr. 16, 2021

Related U.S. Application Data
(60) Provisional application No. 63/013,645, filed on Apr. 22, 2020.

(51) Int. Cl. A01G 20/35; A01B 69/04

(52) U.S. Cl. CPC A01G 20/35; A01B 69/008

(57) ABSTRACT

Disclosed is a device for the automated repair of pitch marks. The device includes a frame that supports a forward sensor array and front and rear rollers. The rollers permit the device to travel across the surface of a green or fairway. A pair of X-Y transfer arms are positioned behind the sensor array and support a pitch-mark repair tool. The X-Y transfer arms function to move the repair tool to the location of any pitch-marks detected by the sensor array. The apparatus can be driven across a grassy surface for the purpose of locating and repairing any pitch-marks.

### CROSS REFERENCE TO RELATED APPLICATIONS

This application claims priority to co-pending Provisional Patent Application Ser. No. 63/013,645, filed on Apr. 22, 2020, entitled “Apparatus for the Automated Repair of Pitch Marks,” the contents of which is fully incorporated herein for all purposes.

### TECHNICAL FIELD

This disclosure relates to a device for the automated repair of pitch marks. More particularly, the present disclosure relates to a device that can move across a grassy surface, find pitch marks, and utilize a tool to repair the pitch marks.

### BACKGROUND OF THE INVENTION

Golf is a sport of ever increasing popularity. Increasing numbers of people in the sport has led to a corresponding increase in foot traffic on greens and fairways. This, in turn, has increased the damage being suffered to greens and fairways. One of the most common forms of damage comes from ball marks. These marks are the result of golf balls landing on greens and fairways at significant speeds. This impact causes deformations in the surface of the turf. These dents or gouges are commonly referred to as “pitch-marks” or “ball-marks.” Many golfers are either unwilling or unable to locate and repair these marks. In the case of greens, unrepaired marks create further damage over time. In the case the greens, these marks can severely and negatively impact the roll of a golf ball. A ball rolling across the mark does not roll true and can be deflected off-line. Golf course superintendents constantly struggle to find ways to efficiently repair pitch-marks.

Over the years, various hand held tools have been developed to repair pitch-marks. These tools can be worn on a visor or belt clip and include a series of teeth. The player inserts the teeth into the area around the periphery of the pitch mark in an effort to fill the pitch-mark with turf or soil. Players subsequently use a putter to press down upon the pitch mark to flatten any upstanding pieces of turf or soil. This is generally a time consuming and labor intensive process that is entirely dependent on the player seeing the pitch-mark and being willing to take the time to fix it. However, due to poor lighting conditions or the pitch-mark blending into the surrounding surface, often times players are simply unware that a pitch-mark has been created. Other times, players are preoccupied or otherwise unwilling to take the time and energy to repair their pitch-marks. As a result, pitch-marks continue to be a common presence on most golf courses.

As a result, there is a need for an automated way of detecting and repairing pitch-marks. There is also a need for an apparatus that can be used by golf course superintendents to systematically locate and repair pitch-marks that may exist anywhere on a golf course. The apparatus of the present disclosure is intended to fulfill these and other needs present in the art.

### SUMMARY OF THE INVENTION

This disclosure relates to a device for the automated repair of pitch-marks.

One of the advantages of the apparatus of the present disclosure is that it allows pitch-marks to be systematically located and repaired.

Yet another advantage of the present disclosure is to allow pitch-marks to be repaired in an automated fashion and with little or no physical exertion.

Another advantage is to provide an apparatus that can be driven across a green so that the entirety of the green can be eradicated of pitch-marks.

A further advantage is provided by including a sensor array across the front of the apparatus and a repair tool that can be positioned via X-Y transfer arms, such that pitch-marks detected by the array can be repaired by a tool positioned by the X-Y transfer arms.

Still yet a further possible advantage is to provide a repair tool that is driven by a fully autonomous driving system to thereby allow fairways and greens to be repaired during non-operating hours and with little, if any, human interaction.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a plan view of the apparatus of the present disclosure.

FIG. 2 is a perspective view of the apparatus of the present disclosure.

FIG. 3 is a detailed view of the pitch repair tool of the present disclosure.

Similar reference numerals refer to similar parts throughout the several views of the drawings.

Parts List

| | |
|---|---|
| 20 | Apparatus |
| 22 | Frame |
| 24 | First Side of Frame |
| 26 | Second Side of Frame |
| 28 | Rear of Frame |
| 32 | Front of Frame |
| 34 | Rear Roller |
| 36 | Front Roller |
| 38 | X-Transfer Arm |
| 42 | Y-Transfer Arm |
| 44 | Repair Tool |
| 46 | Sensor Array |
| 48 | Sensor within Array |
| 52 | Microprocessor |
| 54 | Turf |
| 56 | Pitch Mark |

### DETAILED DESCRIPTION OF THE DRAWINGS

The present disclosure relates a device for the automated repair of pitch marks. The device includes a frame that supports a forward sensor array and front and rear rollers. The rollers permit the device to travel across the surface of a green or fairway. A pair of X-Y transfer arms are positioned behind the sensor array and support a pitch-mark repair tool. The X-Y transfer arms function to move the repair tool to the location of any pitch-marks detected by the sensor array. The apparatus can be driven across a grassy surface for the purpose of locating and repairing any pitch-marks. The various features of the present apparatus, and the manner in which they interrelate, are described in fuller detail hereinafter.

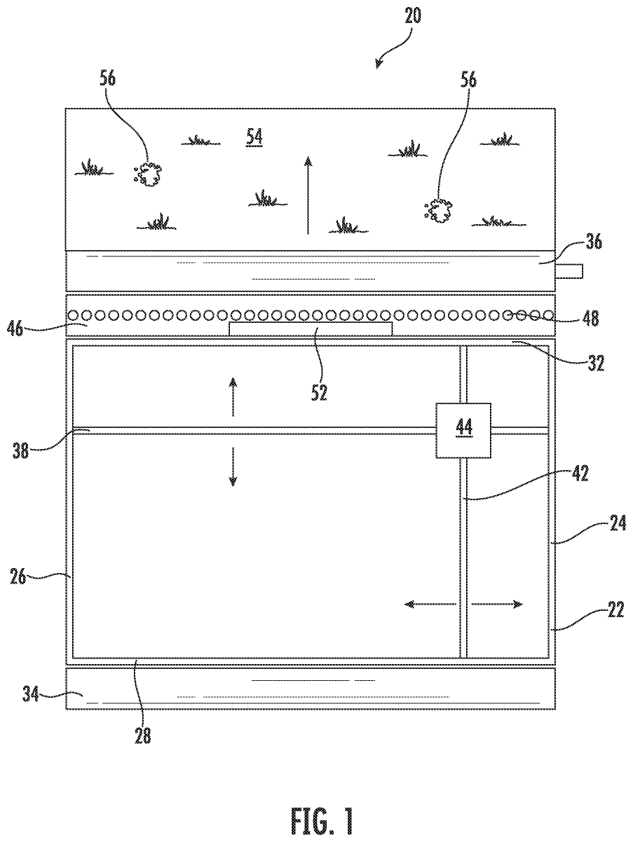

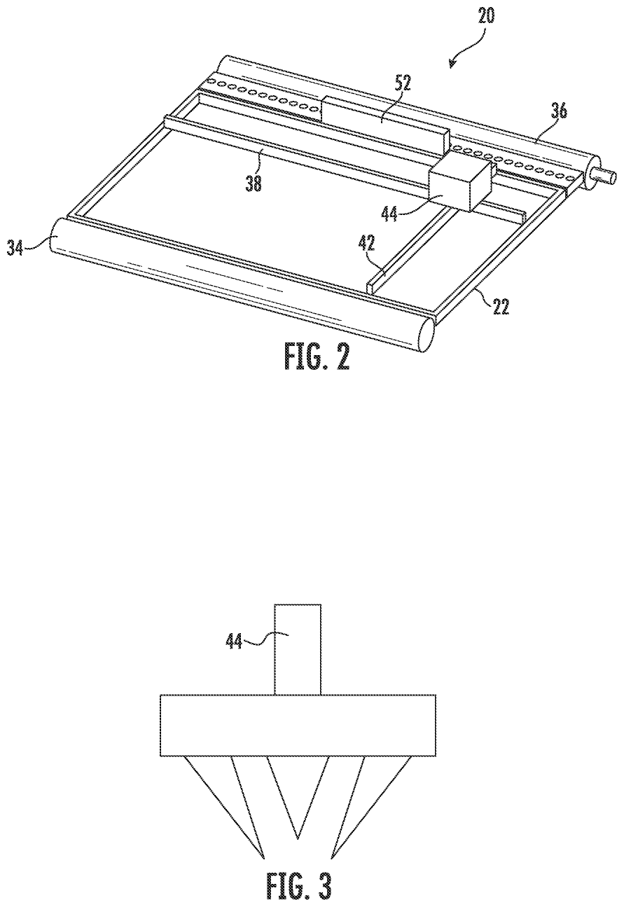

The apparatus is generally depicted in the plan view of FIG. 1. Apparatus 20 includes a rectangular frame 22 consisting of first and second side frame elements (24, 26) as well as rear and front frame elements (28, 32). Although a rectangular frame is depicted, the use of other shapes and sizes are within the scope of the present disclosure. Apparatus 20 can be maneuvered over the surface of a green or fairway via a pair of rollers. More specifically, a rear roller 34 is rotatably mounted to the rear of apparatus 20, while a front roller 36 is rotatably mounted to the front. Front roller 36 can optionally pivot from side to side to steer apparatus 20. Steering can optionally be achieved via the rear roller 34 or by providing two separate rollers rotating at different speeds. An X-transfer arm 38 is mounted between the two side frame elements (24, 26) while a Y-transfer arm 42 is mounted between the rear and front elements (28, 32). Motors and associated gearing can be provided to allow Y-transfer arm 42 to move between the two side frame elements (24, 26); X-transfer arm 38 is similarly mounted to allow it to move between the rear and front elements (28, 32). X-Y transfer arms (38, 42) are used to movably position a repair tool 44. Namely, X-transfer arm 38 is used to position tool 44 anywhere along the X-axis between frame elements 28 and 32. Likewise, Y-transfer arm 42 is used to position tool 44 anywhere along the Y-axis between frame elements 24 and 26. The two arms (38, 42) thereby allow tool 44 to be positioned at any location within the frame of apparatus 20. Repair tool 44 can be any of a variety of turf repair tools, including divot repair tools. In the depicted embodiment, repair tool 44 includes a set of inwardly angled teeth (FIG. 3) that can be selectively inserted into the turf and optionally rotated.

A sensor array 46 is located along the forward edge of apparatus 20. Array is comprised of a series of individual sensors 48. Sensor 48 can be proximity sensor utilizing an electromagnetic field or electromagnetic radiation to sense the proximity of nearby objects. Sensor 48 can thereby detect any sudden changes to the surface of the underlying green or fairway. Sensor 48 is preferably calibrated to distinguish normal undulations from pitch-marks and ball-marks. Once a sensor 48 within array 46 detects a pitch-mark, this information is sent to microprocessor 52. Microprocessor 52 computes the position of the pitch-mark along the x-axis as a function of which sensor 48 within the array 46 is triggered. Thereafter, microprocessor 52 computes a corresponding X-Y coordinate for the X-Y transfer arms (38, 42) taking into account the forward speed of apparatus 20. This computation allows apparatus 20 to continually move as pitch-marks are being repaired by tool 44. Microprocessor 52 can also control apparatus 20 to slow down or stop as the repair is being carried out. In the event apparatus 20 stops to carry out the repairs, Y-transfer arm 42 may be eliminated. In the preferred embodiment, rear and front rollers (34, 36) are heavy cylinders such that the turf is flattened both before and after any repairs are carried out.

In use, apparatus 20 is driven over the surface of turf 54. This may be a fairway, a green, or any other part of the golf course. Turf 54 includes one or more ball-marks or pitch-marks 56 within its surface. Ball-marks or pitch-marks are sometimes referred to as divots. These marks may be difficult for an individual to observe. Apparatus 20 can be pushed by a user, can be semi-automated via mechanical means, or optionally can be fully autonomous via a GPS navigation system. Another guidance system could be achieved via buried inductance wires that dictate the travel of apparatus 20. In either event, the front roller 36 will first be driven over any pitch-marks 56. Thereafter, any portion of pitch-mark extending above the surface of turf 54 will be detectable by one of the sensors 48 of array 46. Microprocessor 52 then computes an X-Y coordinate corresponding to the position of pitch-mark 56 taking into account the forward motion of apparatus 20. The X-Y transfer arms (38, 42) will then be moved via motors and associated gearing to position repair tool 44 over the surface of pitch-mark 56. Once in position, tool 44 will be driven into the pitch-mark 56. This actuation of tool 44 can be done manually by a user or automatically via one or more motors. This action will aerate the soil around the mark and help fill in any missing soil. Finally, the repaired pitch-mark 56 will be smoothed over by passage of rear roller 34.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A device for the automated repair of pitch marks within turf, the device comprising:
a frame comprising front and rear frame elements and first and second side frame elements, the frame being in a rectangular configuration and defining a bounded area;
a front roller interconnected to the front frame element and a rear roller interconnected to the rear frame element, a motor associated with the front and rear rollers whereby the device can be powered for forward and rearward movement upon the turf;
a divot repair tool, the tool comprising a series of inwardly angled teeth, the divot repair tool being configured to repair pitch marks within the turf;
an X-transfer arm and a Y-transfer arm interconnected to the frame and the divot repair tool, positioning motors for locating the X-transfer arm anywhere between the front and rear frame elements and the Y-transfer arm anywhere between the first and second side frame elements, whereby the X and Y transfer arms can selectively position the divot repair tool anywhere within the bounded area;
a sensor array associated with the front frame element and continuously scanning the turf to detect any uneven surfaces, an uneven surface being interpreted as a pitch mark;
a microprocessor in communication with the sensor array and the positioning motors, whereby when a pitch mark is detected the microprocessor can thereafter determine a corresponding X-Y target location within the bounded area based upon a forward speed of the device, the positing motors subsequently moving the divot repair tool to the X-Y target location to effect a repair of the pitch mark.

2. A device for the automated repair of pitch marks within turf, the device comprising:
a frame comprising front and rear frame elements and first and second side frame elements, the frame defining a bounded area;
a front roller interconnected to the front frame element and a rear roller interconnected to the rear frame element, a motor associated with the front and rear rollers whereby the device can be powered for forward and rearward movement upon the turf;
a divot repair tool, the divot repair tool being configured to repair pitch marks within the turf;
X and Y transfer arms interconnected to the frame and the divot repair tool, the X and Y transfer arms positioning the divot repair tool via positioning motors to a location within the bounded area;
a sensor array associated with the front frame element and continuously scanning the turf to detect any uneven surfaces, an uneven surface being interpreted as a pitch mark.

3. The device as described in claim 2 further comprising a microprocessor in communication with the sensor array and the positioning motors, whereby when a pitch mark is detected the microprocessor can thereafter determine a corresponding X-Y target location within the bounded area.

4. The device as described in claim 3 wherein the X-Y target location is computed based upon a forward speed of the device, the positing motors subsequently moving the divot repair tool to the X-Y target location to effect a repair of the pitch mark.

5. The device as described in claim 3 wherein the microprocessor includes a program for maneuvering the device along a predetermined route over the turf.

6. The device as described in claim 2 wherein the device utilizes GPS navigation and is fully autonomous.

7. The device as described in claim 2 wherein two rear rollers are provided and wherein the device can be turned via the differential rotation of the two rear rollers.

8. The device as described in claim 2 wherein the device is maneuvered by a user via a remote control.

9. The device as described in claim 2 wherein the sensor array utilizes an electromagnetic field to sense the proximity of the turf and the presence of any pitch marks.

10. The device as described in claim 2 wherein the divot repair tool comprising a series of inwardly angled teeth.
